(19) United States
(12) Patent Application Publication
(10) Pub. No.: US 2007/0101327 A1
(43) Pub. Date: May 3, 2007

(54) Method and system for providing a potential deadlock source code debugger warning

(76) Inventors: Dean J. Burdick, Austin, TX (US); Basu Vaidyanathan, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/260,622

(22) Filed: Oct. 27, 2005

(51) Int. Cl. G06F 9/46

(52) U.S. Cl. 718/100

(57) ABSTRACT

A method and system for providing a potential deadlock source code debugger warning are disclosed. According to one embodiment, a method is provided in which whether a potential deadlock condition exists is determined in response to a receipt of a request to resume a single selected thread of a plurality of threads of an application process. Following such a determination in the described method embodiment a deadlock advisory message is issued in response to a determination that the potential deadlock condition exists, or alternatively, the single selected thread is resumed in response to a determination that the potential deadlock condition does not exist.

### BACKGROUND

1. Technical Field

Embodiments of the present invention relate generally to the development of application software and more particularly to a method and system for providing a potential deadlock source code debugger warning.

2. Description of the Related Art

Deadlock is a condition in which the continued execution of each of a group of two or more processing elements depends upon the occurrence of a condition which will only occur following the continued execution of one of the other processing elements of the group such that no forward execution progress by any of the group of processing elements is made. A processing element is a data processing system component which may be implemented in hardware (e.g., as a general or special-purpose processor or processor core, a programmable logic device, or the like), firmware, software, or a combination thereof.

Software processing elements may include any of a number of components such as processes or threads within a multithreading data processing system. In such a multithreading system, each application is partitioned among one or more processes with each process being associated with an address space, such that different processes can operate concurrently without resource conflicts. Each process in turn includes one or more threads of control, or “threads.” A thread is a unit or path of execution within an associated or “parent” process. Each process' threads share a common address space, thus simplifying inter-thread communication and reducing context switch time between threads as compared to that between processes or applications.

While providing a number of benefits, such multithreading data processing systems present a number of challenges including the avoidance of deadlock. Although deadlock prevention is a significant issue with respect to actual program execution, it is similarly critical in the context of application programming debugging. For example, conventional source code debuggers provide functionality such that a single thread of a group of threads (e.g., of a process being debugged) may be resumed while other threads of the group remain suspended. Such a situation may occur, for example, where a breakpoint instruction is reached (causing process execution to be stopped and all threads to be suspended) and a user command is subsequently received to resume a single selected thread. If one of the remaining suspended threads has acquired exclusive access to a resource necessary for the continued execution of the thread to be resumed, a deadlock condition may result.

Typically, such deadlock conditions are ignored by a source code debugger to be resolved, after they have already occurred, by a debugger user or software developer. Consequently, corrective action is frequently necessary once deadlock has occurred to enable debugging to continue (e.g., debugger and/or associated data processing system restart). Latency resulting from the intermittent access to debugging resources and additional corrective operations needed in turn frequently cause increased debugging and application process development times and consequently may yield increased bugs or errors in released applications.

### SUMMARY

A method and system are disclosed herein for providing a potential deadlock source code debugger warning. According to one embodiment, a method is provided in which whether a potential deadlock condition exists is determined in response to a receipt of a request to resume a single selected thread of a plurality of threads of an application process. Furthermore, in the described embodiment, a deadlock advisory message is issued in response to a determination that the potential deadlock condition exists, and the single selected thread is resumed in response to a determination that the potential deadlock condition does not exist.

The foregoing is a summary and thus contains, by necessity, simplifications, generalizations and omissions of detail; consequently, those skilled in the art will appreciate that the summary is illustrative only and is not intended to be in any way limiting. As will also be apparent from the accompanying description, the operations disclosed herein may be implemented in a number of ways including implementation in hardware, software, firmware, or a combination thereof, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous features and advantages made apparent to those skilled in the art by referencing the accompanying drawings in which:

FIG. 1 illustrates a high-level internal block diagram of a data processing system including a source code debugger according to an embodiment of the present invention;

FIG. 2 depicts a high-level block diagram of a memory or address space of a data processing system such as that illustrated in FIG. 1 according to one embodiment of the present invention;

FIG. 3 illustrates deadlock indication data such as that depicted in FIG. 2 in greater detail according to one embodiment of the present invention;

FIG. 4 depicts a graphical user interface illustration of a source code debugger according to one embodiment of the present invention;

FIG. 5 illustrates a high-level flow diagram of a process to maintain deadlock indication data according to one embodiment of the present invention; and

FIG. 6 depicts a high-level flow diagram of a process to provide a potential deadlock advisory message according to one embodiment of the present invention.

The use of similar reference symbols in different drawings is intended to indicate similar or identical items.

### DETAILED DESCRIPTION OF AN ILLUSTRATIVE EMBODIMENT

The following sets forth a detailed description of at least the best contemplated mode for carrying out the one or more systems, devices and/or processes described herein. The description is intended to be illustrative and should not be taken to be limiting. In the following detailed description, numerous specific details such as specific method orders, structures, elements, and connections have been set forth. It is to be understood however that these and other specific details need not be utilized to practice embodiments of the present invention. In other circumstances, well-known structures, elements, or connections have been omitted, or have not been described in particular detail in order to avoid unnecessarily obscuring this description.

References within the specification to “one embodiment,” “an embodiment,” or “embodiments” are intended to indicate that a particular feature, structure, or characteristic described in connection with the embodiment is included in at least one embodiment of the present invention. The appearance of such phrases in various places within the specification are not necessarily all referring to the same embodiment, nor are separate or alternative embodiments mutually exclusive of other embodiments. Moreover, various features are described which may be exhibited by some embodiments and not by others. Similarly, various requirements may be described which are applicable to some embodiments but not other embodiments.

Embodiments of the present invention provide a method and system for providing a potential deadlock source code debugger warning. According to one embodiment, an advisory/warning message is provided to a user of a source code debugger before a debugger command is issued to continue execution of a single thread while all the threads of the process being debugged are suspended. In the described embodiment, the source debugger is configured to determine whether deadlock indication data of an associated thread library indicates that one or more library global locks are held by any process threads other than the current selected thread. The debugger then issues an advisory message to a user about a possible deadlock if and when the user requests (e.g., via a debugger command) that only the current selected thread be resumed.

Accordingly, a different course of action may then be taken by the user to avoid deadlock since the potential deadlock condition has been identified and the user has been informed, for example, execution of all threads of an associated process, rather than just the currently selected process thread may be continued. In one embodiment of the present invention, a count is maintained of all library global locks that are currently held by any application process as deadlock indication data stored within the threads library. Although different application processes may have shared access to the threads library, such a separate deadlock indication data counter is maintained privately for each process. When a user issues a command to continue execution of any thread, a corresponding deadlock indication data count will be assessed. If the counter's value is non-zero, then an advisory message will be displayed and the command or request is, at least temporarily, not executed. The user is then prompted to either issue the command again and risk of possible deadlock or issue a different command to continue.

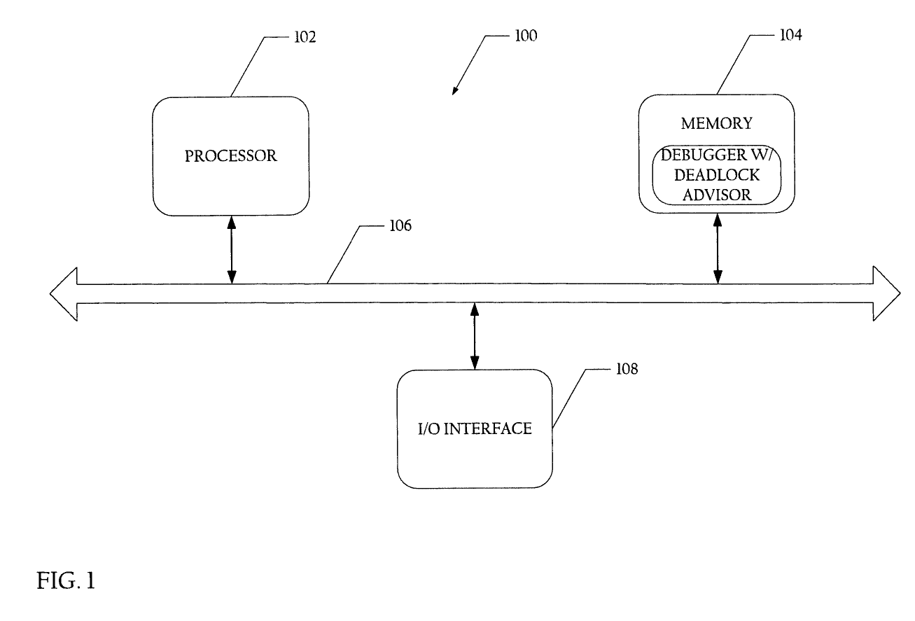

FIG. 1 illustrates a high-level internal block diagram of a data processing system including a source code debugger according to an embodiment of the present invention. While a particular number and arrangement of elements have been illustrated with respect to data processing system 100 of FIG. 1, it should be appreciated that embodiments of the present invention are not limited to data processing systems having any particular number, type, or arrangement of components and so many encompass a wide variety of data processing system types, architectures, and form factors (e.g., network elements or nodes, personal computers, workstations, servers, or the like). Data processing system 100 of the illustrated embodiment includes a processor 102 coupled to a memory 104 utilizing a bus 106. Memory 104 may comprise any of a number of system memory-type storage elements such as random access memory (RAM), read-only memory (ROM), flash memory, and/or cache.

Data processing system 100 of the illustrated embodiment further comprises an input/output (I/O) interface 108 coupled to bus 106 to communicatively couple one or more I/O devices (not shown) to data processing system 100. Exemplary I/O devices may include traditional I/O devices such as keyboards, displays, printers, cursor control devices (e.g., trackballs, mice, tablets, etc.), speakers, and microphones; storage devices such as fixed or “hard” magnetic media storage devices, optical storage devices (e.g., CD or DVD ROMs), solid state storage devices (e.g., USB, Secure Digital SD™, CompactFlash™, MMC, or the like), removable magnetic medium storage devices such as floppy disks and/or tape, or other storage devices or mediums; and wired or wireless communication devices or media (e.g., communication networks accessed via modem or direct network interface).

Embodiments of the present invention may include software, information processing hardware, and various processing operations further described herein. The features and process operations of the present invention may be embodied in executable instructions embodied within a machine-readable medium such as memory 104, a storage device, a communication device or medium, or the like. A machine-readable medium may include any mechanism that provides (i.e., stores and/or transmits) data in a form readable by a machine (e.g., data processing system 100). For example, a machine-readable medium includes but is not limited to: random access memory (RAM); read only memory (ROM); magnetic storage media; optical storage media; flash memory devices; electrical, optical, and/or acoustical propagated signals (e.g., carrier waves, infrared signals, digital signals, etc.); or the like.

The described executable instructions can be used to cause a general or special purpose processor such as processor 102, programmed with the instructions, to perform operations, methods or processes of the present invention. Alternatively, the features or operations of the present invention may be performed by specific hardware components that contain hard-wired logic for performing the operations, or by any combination of programmed data processing components and custom hardware components.

While embodiments of the present invention have been described in the context of fully functional data processing system; those skilled in the art will appreciate that such embodiments are capable of being distributed as a program product in a variety of forms and of being applied equally, regardless of the particular type of machine-readable or signal-bearing media used to carry out the distribution. Examples of signal-bearing media include recordable media such as floppy disks and CD-ROM, transmission type media such as digital and analog communications links, as well as media storage and distribution systems. Embodiments of the present invention may similarly be implemented using software modules used to perform certain operations or tasks. The described software modules may include script, batch, library, or other executable files and may be stored on a machine- or computer-readable medium. Thus, the modules may be stored within a computer system memory to configure a data processing or computer system to perform one or more functions of a software module. Various types of machine or computer-readable storage media as discussed herein may be used to store modules according to embodiments of the present invention.

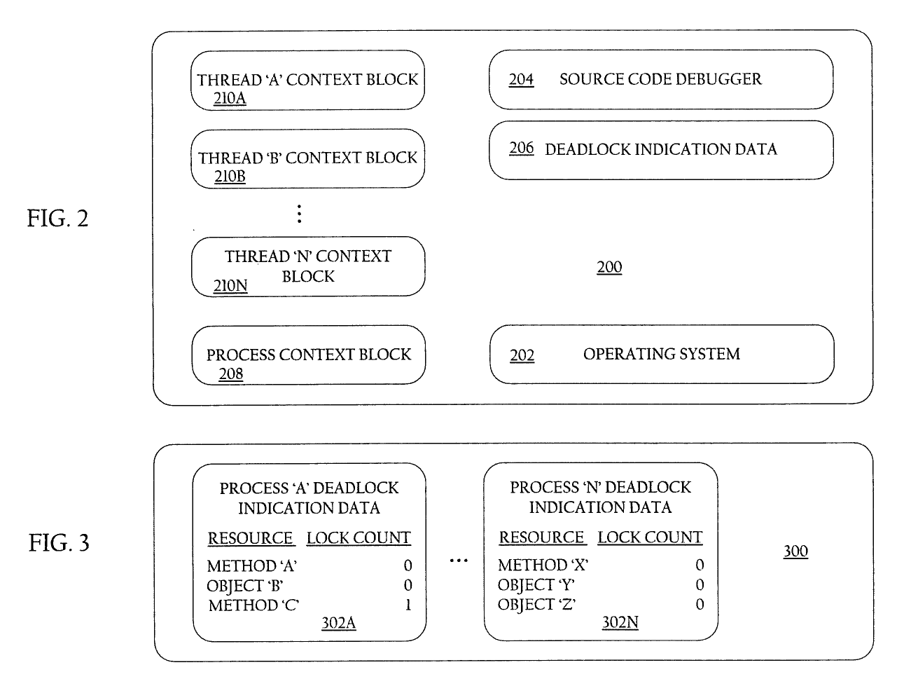

FIG. 2 depicts a high-level block diagram of a memory or address space of a data processing system such as that illustrated in FIG. 1 according to one embodiment of the present invention. Address space 200 of the illustrated embodiment includes an operating system 202 (e.g., the AIX operating system provided by International Business Machines Corporation of Armonk, N.Y.) and a source code debugger 204 coupled with deadlock indication data 206 for controlling and analyzing the execution of one or more software application processes according to one or more embodiments of the present invention. Address space 200 further includes an exemplar application process as embodied by process context block 208 and associated thread context blocks 210A-210N. While context data for a single process has been depicted herein for the sake of simplicity, any number of processes and/or threads per process may be provided in alternate embodiments.

In the illustrated embodiment of FIG. 2, process context block 208 comprises data specifying a common address space or other resource shared among each of a number of associated threads. Attributes associated with each of the described threads (e.g., data specifying processor state, private stack pointers, thread priority, remaining execution quanta, or the like) as well as data identifying a common process (e.g., a reference to process context block 208) are then in turn specified utilizing a corresponding one of thread context blocks 210A-210N. Deadlock indication data 206 may be maintained by any of a number of elements or entities such as source code debugger 204, operating system 202, and/or a management process or thread of an associated thread library (not illustrated). According to one embodiment, source code debugger 204 utilizes deadlock indication data 206 to identify a potential deadlock condition among the threads whose attributes are specified by thread context blocks 210A-210N and to generate a deadlock advisory message or warning as described herein.

FIG. 3 illustrates deadlock indication data such as that depicted in FIG. 2 in greater detail according to one embodiment of the present invention. More specifically, deadlock indication data 300 of the illustrated embodiment of FIG. 3, includes discrete deadlock indication data 302A-302N for each of a number of application processes. Each unit or set of deadlock indication data 302 includes data specifying an identifier of a corresponding process and a counter value specifying the number of synchronization elements (e.g., global lock) currently held by threads of the identified process. According to one embodiment of the present invention, the described counter values specify the number of global locks held on a thread library shared among all threads of the corresponding process or an element or object thereof.

In the present description, the descriptor “N” is intended to indicate some integer number of elements. Use of the descriptor “N” with regard to multiple sets of elements within the present description is not intended to indicate necessarily the same number of elements in each case.

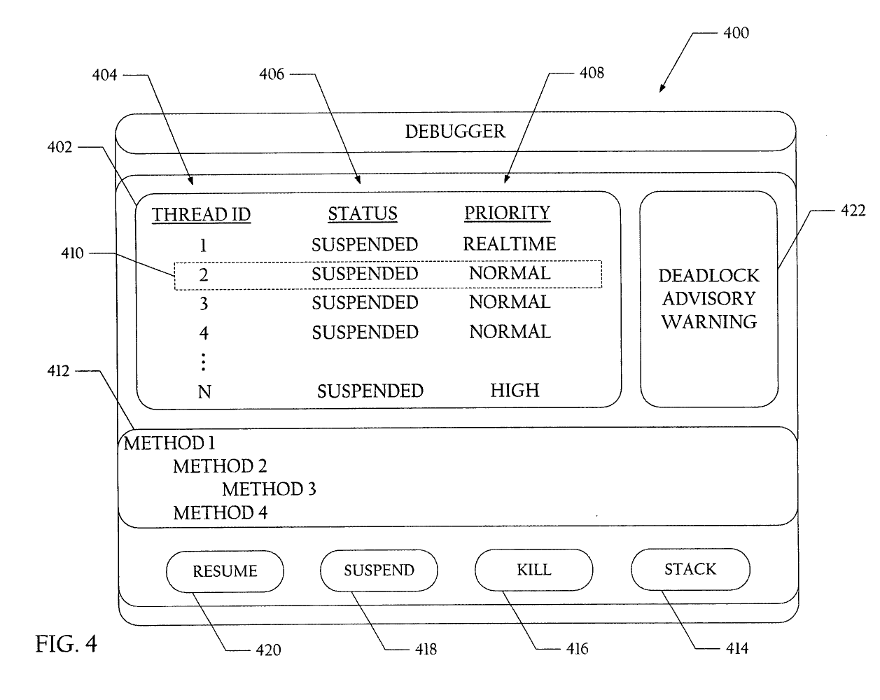

FIG. 4 depicts a graphical user interface illustration of a source code debugger according to one embodiment of the present invention. In the illustrated embodiment, a source code debugger 400 is provided having a number of display elements and control elements. Thread data display element 402 of the depicted embodiment presents thread data for each thread of a process being debugged. Such thread data includes thread identifier data 404, thread execution status 406, and thread priority 408 in the depicted embodiment, but may include other data associated with one or more threads in alternative embodiments. Thread data display element 402 further includes a thread selection indicator 410 used to specify a thread currently being analyzed or manipulated or to be analyzed or manipulated.

Call stack display element 412 of the depicted embodiment presents data representing a call stack of a selected thread (e.g. a thread selected or identified using thread selection indicator 410). The illustrated call stack includes data specifying code sequence (e.g., methods, routines, procedures, functions, or the like) identifiers, thus specifying the order in which such code sequences were invoked. A call stack may additionally include other data such as variables or references utilized by such code sequences encapsulated, along with the described code sequence identification data, in a stack frame element. While a nested structure has been depicted in the embodiment of FIG. 4, other representations of code sequences and their order of invocation are contemplated in alternative embodiments of the present invention. In yet another embodiment, source code being currently executed may be displayed in a similar manner.

In the embodiment of FIG. 4, a call stack control element 414 may be utilized, via user manipulation, to cause a call stack of a selected thread (e.g. a thread selected or identified using thread selection indicator 410) to be displayed via call stack display element 412. In the illustrated source code debugger interface embodiment, a thread kill control element 416 (to “kill” a thread, thus causing execution of an instance of the thread to be permanently ceased), a thread suspend control element 418 (to suspend execution of a thread instance), and/or a thread resume control element 420 (to resume execution of a thread instance which was previously suspended or “blocked”) may be similarly employed. Source code debugger 400 of the illustrated embodiment further comprises a deadlock advisory display element 422 as shown.

According to one embodiment, deadlock advisory display element 422 is utilized to display a deadlock advisory message or warning to a user in response to the detection of the existence of a potential deadlock condition as described herein. Such a deadlock advisory message may be displayed to a user of source code debugger 400 following the receipt of a user request via a manipulation, selection, or activation of thread resume control element 420 to resume a single selected thread. For example, where a user requests that execution of a selected thread (e.g., thread “2” of thread data display element 402) be resumed where all other threads are currently suspended and deadlock indication data indicates that a global lock or other thread synchronization element is held by one or more of those threads to remain suspended, a deadlock advisory message may be generated and displayed via deadlock advisory display element 422.

According to one embodiment of the present invention, deadlock advisory display element 422 comprises a constantly displayed message line, status window, or the like via which a deadlock advisory message or warning may be displayed. In another embodiment however, deadlock advisory display element 422 may be displayed only upon detection of a potential deadlock condition (e.g., a dialog box, check box, or other “pop-up” type display element). In one particular embodiment, deadlock advisory display element 422 comprises a “pop-up” dialog box including a user prompt to confirm a previous instruction or command (e.g., via thread resume control element 420) to resume a single thread of a plurality of threads (e.g., of an application process being debugged), where all other threads of the plurality remain blocked or otherwise suspended.

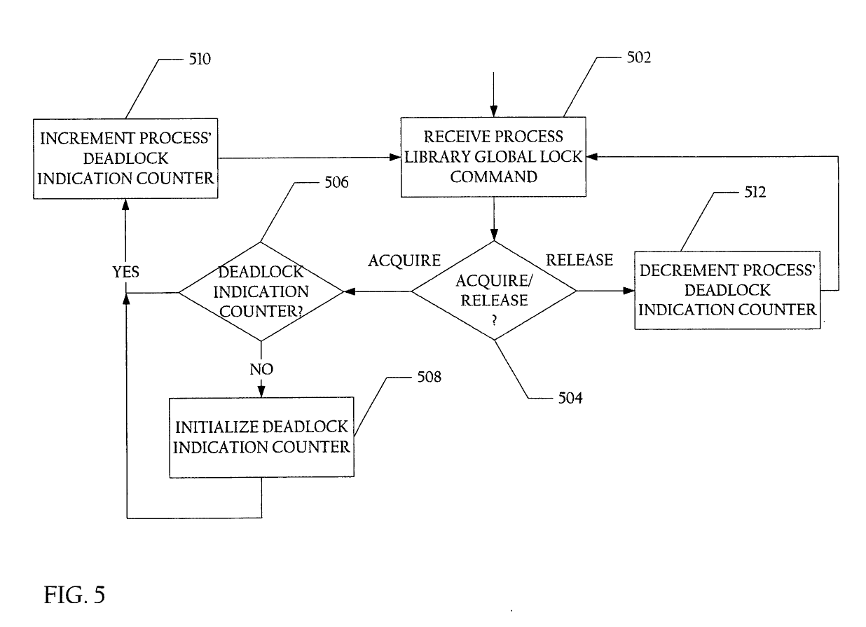

FIG. 5 illustrates a high-level flow diagram of a process to maintain deadlock indication data according to one embodiment of the present invention. In the illustrated process embodiment, a library global lock command is initially received from a process of an associated multithreaded programming environment of the present invention (process block 502). A library global lock, as discussed herein, may include a lock, mutex, semaphore, or other synchronization element used in conjunction with a shared library, and applied to either the shared library as a whole or to one or more selected objects, elements, and/or code sections (e.g., methods, procedures, routines, or the like) within such a shared library.

While a “receipt” and “command” have been indicated herein for the sake or simplicity, this selection of terminology should not be taken as limiting to embodiments of the present invention. For example, in alternative embodiments of the present invention similar functionality may be provided via the detection of an event, (e.g., a request for access, access, or grant of a request for access to a data processing system resource). Moreover, while the “command” of the illustrated embodiment of FIG. 5 has been described as originating from a process, this description is intended to convey that such a command, event detection, or the like, is received from, initiated by, or otherwise associated with, an element or object within a process context or otherwise associated with a process.

Similarly, while a “library” and “global lock” have been utilized for purposes of illustration within the context of the embodiment of FIG. 5, alternative embodiments of the present invention may be used in conjunction with other data processing system resources (e.g., a shared resource or synchronization element associated therewith) as well as other synchronization elements. Once a process' library global lock command has been received or detected, a determination is made whether the received command is to acquire a global lock or to release a global lock previously acquired (process block 504). Following a determination that the received library global lock command is to acquire a lock, a further determination is made whether an associated deadlock indication counter or other associated deadlock indication data has been previously generated (process block 506).

According to alternative embodiments of the present invention, deadlock indication data such as the described deadlock indication counter may be maintained at various levels of granularity and in combination with various other data. For example, as previously described herein a deadlock indication counter may be maintained for each application process within a multithreaded programming environment (e.g., a data processing system or portion thereof, a communications network, or the like). Deadlock indication counters may also be maintained specific to, or including data specifying, an individual thread or group of threads, or an individual data processing system resource or group of resources.

While a counter has been used herein for purposes of illustration with respect to the embodiment shown in FIG. 5, deadlock indication data may be stored in various forms. According to one embodiment, deadlock indication data may be stored as a deadlock indication flag used to indicate the presence or absence of a potential deadlock condition. The described deadlock indication flag may be formed using any of a number of techniques, for example, by setting and clearing individual flags for each instance in which a global library lock is acquired and released and logically combining (e.g., ORing) all of the individual flags to form the described deadlock indication flag.

In response to a determination that an associated deadlock indication counter or other associated deadlock indication data has not been previously generated, a new deadlock indication counter is initialized (process block 508) as shown. In one embodiment, counter initialization includes the generation of the counter itself (e.g., via the allocation of memory to store the counter's value) followed by the storage within the counter of an initial value (e.g., the binary value “0”). Once initialized, or alternatively following a determination that an associated deadlock indication counter or other associated deadlock indication data has been previously generated, the associated counter is incremented (process block 510).

While a particular technique for managing or maintaining deadlock indication (e.g., a deadlock indication pointer) has been depicted and described herein for purposes of illustration, it should be appreciated that alternative techniques are employed in other embodiments of the present invention. For example, a deadlock counter may be “initialized” only upon the acquisition of an associated resource or synchronization element and to another value (e.g., the binary value “1”), thus bypassing or altering the described increment operation in some circumstances.

Following a determination that the received library global lock command is to release an existing lock (process block 504), the associated deadlock indication counter or data is decremented (process block 512) as shown. According another embodiment of the present invention, a determination is made whether the described decrement operation causes the associated deadlock indication counter to reach a predetermined value (e.g., binary “0”) at which point one or more resources (e.g., memory storage locations) associated with the counter are released or deallocated.

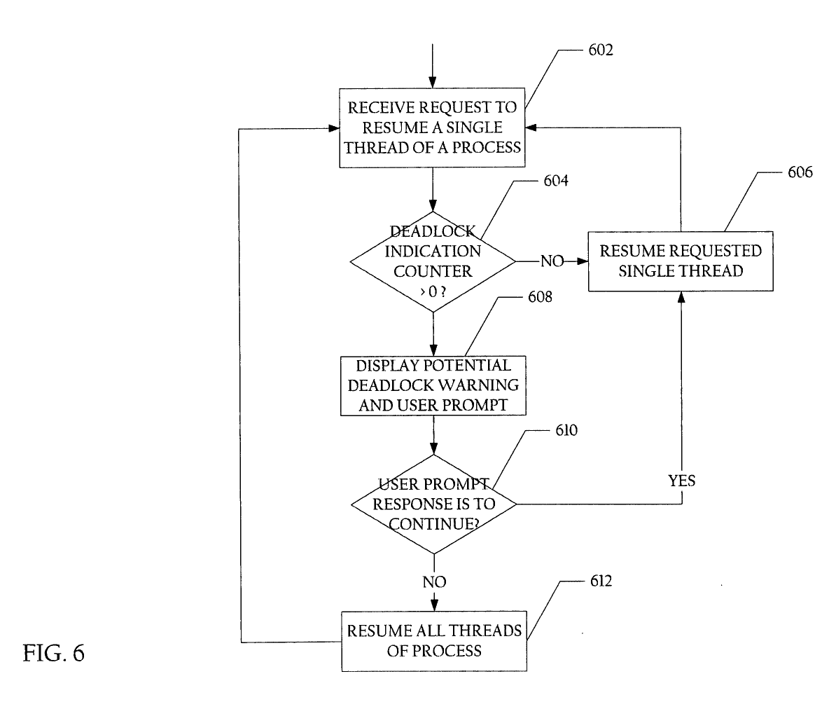

FIG. 6 depicts a high-level flow diagram of a process to provide a potential deadlock advisory message according to one embodiment of the present invention. In the illustrated process embodiment, a request is initially received to resume a single thread of an application process (process block 602) within a multithreaded programming environment. Such a request may be received, for example, through a user interaction or manipulation of an interface (e.g., a display and/or control element) of a source code debugger. According to one exemplary embodiment of the present invention, such a request is received via a user manipulation of thread resume control element 420 as depicted in FIG. 4 following the suspension of all threads of a process being debugged (e.g., upon reaching a predetermined debug breakpoint).

Once a request to resume a single selected thread of a plurality of process threads is received, deadlock indication data is consulted to determine if a potential deadlock condition exists. More specifically, in the illustrated embodiment of FIG. 6, a determination is made whether or not an associated deadlock indication counter specifies a value that is greater than binary “0” (process block 604). While a binary value of “0” has been depicted and described herein, in alternative embodiments any of a number of threshold values may be employed.

According to the depicted embodiment, such a deadlock indication counter is specific to a particular application process and indicates the number of global thread library locks or other similar thread synchronization elements outstanding or currently held by threads of the described plurality. In another embodiment, a deadlock indication counter could be associated with a particular shared data processing system resource (e.g., a code section or “method”, a shared object or data element, a synchronization element, or the like). Moreover, such deadlock indication data may be utilized to specify the identity of a corresponding thread for each outstanding or currently held thread synchronization element or “lock” such that a determination may be made specifically as to whether any such locks are held by a thread other than the thread to be resumed.

If the described deadlock indication counter is found to indicate a value not greater than binary “0” (thus indicating that no potential deadlock condition currently exists) the received request is fulfilled via the resumption of its subject single thread (process block 606). However, if a determination is made that a potential deadlock condition exists (where the deadlock indication counter is found to indicate a value greater than binary “0”) a potential deadlock advisory message or warning and user prompt is displayed (process block 608) (e.g., via deadlock advisory display element 422 of FIG. 4).

Such a potential deadlock advisory message and prompt may take any of a variety of forms including, for example, text indicating that completion of the requested action may result in a deadlock condition and requesting that a (requesting) user confirm the original request to resume the specified single thread or that alternative action be taken. Such alternative action may be predetermined or dynamically selected and may be specified by a user or by the source code debugger provider. More specifically, in the illustrated embodiment, a response to the described user prompt is received and a determination is made whether the described response indicates that the original request to resume the single selected thread is confirmed and should continue (process block 610) or that some alternative action should be taken.

According to the embodiment of FIG. 6, if the user's response indicates that the original request to resume a single selected thread is to be withdrawn, alternative action is taken in the form of a resumption of all threads of an associated application process (process block 612). Alternatively, if the user's response is determined to have indicated that the original request is to continue, the selected single thread of the original request is resumed (process block 606). In still other embodiments of the present invention other alternative actions may be taken if the original request is not confirmed. For example, rather than resuming all threads of an associated process, at least one additional or alternative thread may be resumed, where the additional or alternative thread is selected randomly or based upon some criteria or thread attribute. Once such alternative action has been taken, other requests may be received and processed as previously described.

As previously described herein, variations may be made in different embodiments of the present invention. For example, while reference has been made to the issuance of a deadlock advisory message in response to a determination that a potential deadlock condition exists, in alternative embodiments no such warning or advisory message need be made. Rather, any request which is determined may cause a potential or actual deadlock condition to arise may be simply ignored or alternative action may be taken immediately without prompting a user and/or alerting them to the potential deadlock.

Although the flow diagrams depicted in FIGS. 5 and 6 indicate a particular order of operation and a specific granularity of process operations, in alternative embodiments the illustrated orders may be varied (e.g., process operations may be performed in another order or performed substantially in parallel) and one or more of the process operations may be coalesced or fragmented. Similarly, addition process operations may be added where necessary in alternative embodiments of the present invention. For example, in alternative embodiments of the present invention a user may be prompted to select alternative or additional threads to resume in response to the detection of a potential deadlock condition as previously described herein.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

Consequently, the invention is intended to be limited only by the scope of the appended claims, giving full cognizance to equivalents in all respects.

What is claimed is:

1. A method comprising:
determining whether a potential deadlock condition exists in response to a receipt of a request to resume a single selected thread of a plurality of threads of an application process;
issuing a deadlock advisory message in response to a determination that said potential deadlock condition exists; and
resuming said single selected thread in response to a determination that said potential deadlock condition does not exist.

2. The method of claim 1, said method further comprising:
invoking said application process utilizing a source code debugger;
suspending each of said plurality of threads utilizing said source code debugger; and
receiving said request to resume said single selected thread of said plurality of threads in response to said suspending.

3. The method of claim 2, wherein
said receiving comprises receiving said request to resume said single selected thread of said plurality of threads via an input interface of said source code debugger, and
said issuing comprises issuing said deadlock advisory message via an output interface of said source code debugger.

4. The method of claim 1, wherein said single selected thread comprises a first thread of said plurality of threads and said determining comprises:
maintaining deadlock indication data specifying whether a thread synchronization element corresponding to a data processing system resource shared by two or more of said plurality of threads is held by a second thread of said plurality of threads; and
determining whether said potential deadlock condition exists utilizing said deadlock indication data.

5. The method of claim 4, wherein said deadlock indication data comprises a counter specifying a number of global thread synchronization elements held by said plurality of threads.

6. The method of claim 1, said method further comprising:
receiving a user command in response to an issuance of said deadlock advisory message;
resuming said single selected thread if said user command comprises a request to continue said request to resume said single thread; and
resuming at least one thread, other than said single selected thread, of said plurality of threads if said user command comprises a request to discontinue said request to resume said single thread.

7. A machine-readable medium having a plurality of instructions executable by a machine embodied therein, wherein said plurality of instructions when executed cause said machine to perform a method, said method comprising:
determining whether a potential deadlock condition exists in response to a receipt of a request to resume a single selected thread of a plurality of threads of an application process;
issuing a deadlock advisory message in response to a determination that said potential deadlock condition exists; and
resuming said single selected thread in response to a determination that said potential deadlock condition does not exist.

8. The machine-readable medium of claim 7, said method further comprising:
invoking said application process utilizing a source code debugger;
suspending each of said plurality of threads utilizing said source code debugger; and
receiving said request to resume said single selected thread of said plurality of threads in response to said suspending.

9. The machine-readable medium of claim 8, wherein
said receiving comprises receiving said request to resume said single selected thread of said plurality of threads via an input interface of said source code debugger, and
said issuing comprises issuing said deadlock advisory message via an output interface of said source code debugger.

10. The machine-readable medium of claim 7, wherein said single selected thread comprises a first thread of said plurality of threads and said determining comprises:
maintaining deadlock indication data specifying whether a thread synchronization element corresponding to a data processing system resource shared by two or more of said plurality of threads is held by a second thread of said plurality of threads; and
determining whether said potential deadlock condition exists utilizing said deadlock indication data.

11. The machine-readable medium of claim 10, wherein said deadlock indication data comprises a counter specifying a number of global thread synchronization elements held by said plurality of threads.

12. The machine-readable medium of claim 7, said method further comprising:
receiving a user command in response to an issuance of said deadlock advisory message;
resuming said single selected thread if said user command comprises a request to continue said request to resume said single thread; and
resuming at least one thread, other than said single selected thread, of said plurality of threads if said user command comprises a request to discontinue said request to resume said single thread.

13. An apparatus comprising:
means for determining whether a potential deadlock condition exists in response to a receipt of a request to resume a single selected thread of a plurality of threads of an application process;
means for issuing a deadlock advisory message in response to a determination that said potential deadlock condition exists; and
means for resuming said single selected thread in response to a determination that said potential deadlock condition does not exist.

14. The apparatus of claim 13, further comprising:
means for invoking said application process utilizing a source code debugger;
means for suspending each of said plurality of threads utilizing said source code debugger; and
means for receiving said request to resume said single selected thread of said plurality of threads in response to a suspension of each of said plurality of threads.

15. The apparatus of claim 14, wherein
said means for receiving comprises means for receiving said request to resume said single selected thread of said plurality of threads via an input interface of said source code debugger, and
said means for issuing comprises means for issuing said deadlock advisory message via an output interface of said source code debugger.

16. The apparatus of claim 13, wherein said single selected thread comprises a first thread of said plurality of threads and said means for determining comprises:
means for maintaining deadlock indication data specifying whether a thread synchronization element corresponding to a data processing system resource shared by two or more of said plurality of threads is held by a second thread of said plurality of threads; and
means for determining whether said potential deadlock condition exists utilizing said deadlock indication data.

17. The apparatus of claim 16, wherein said deadlock indication data comprises a counter specifying a number of global thread synchronization elements held by said plurality of threads.

18. The apparatus of claim 17, wherein,
each of said plurality of threads is associated with a thread class library;
said resource comprises a thread class library resource, and
said global thread synchronization elements comprises a threads library global lock.

19. The apparatus of claim 13, further comprising:
means for receiving a user command in response to an issuance of said deadlock advisory message;
means for resuming said single selected thread if said user command comprises a request to continue said request to resume said single thread; and
means for resuming at least one thread, other than said single selected thread, of said plurality of threads if said user command comprises a request to discontinue said request to resume said single thread.
